(19) United States
(12) Patent Application Publication
(10) Pub. No.: US 2024/0140767 A1
(43) Pub. Date: May 2, 2024

(54) Rotation Control Device and Winch

(71) Applicant: Hall Labs LLC

(72) Inventors: Michael Hall, Provo, UT (US); Tyler Thomas, Salt Lake City, UT (US); Michael Shinedling, Provo, UT (US)

(73) Assignee: Hall Labs LLC, Provo, UT (US)

(21) Appl. No.: 18/050,995

(22) Filed: Oct. 29, 2022

(51) Int. Cl. B66D 5/12; B66D 5/30

(52) U.S. Cl. CPC B66D 5/12; B66D 5/30

(57) ABSTRACT

A device to control rotation is disclosed. The device includes a stationary portion having an internal aperture with a frustoconical inner surface. The device also includes a movable portion having a frustoconical outer surface, adapted to engage the frustoconical inner surface, to stop rotation between the movable portion and the stationary portion when engaged. An input sleeve is included, configured to transmit an applied rotational force to the device, also configured so that, as the input sleeve moves in a first axial direction, the moveable portion engages the stationary portion, and as the input sleeve moves in a second and opposite axial direction, the moveable portion is pushed out of engagement with the stationary portion. The device further includes a one-way rotation governor, non-rotatably attached to the movable portion and non-rotatably attached to a shaft and configured to allow rotation between the movable portion and the shaft in one rotational direction and prevent rotation between the movable portion and the shaft in a second opposite rotational direction.

### TECHNICAL FIELD

This invention relates to controlling the rotation of a shaft and winches with this function.

### BACKGROUND

Rotational devices are useful. For example, they are used to wind in a line, bring an object closer to the device, or lift objects. In some rotational devices, when the force causing the rotation is released, whether that be a manual force or mechanical force, the rotation will go in the opposite direction. This can be dangerous, as uninhibited rotation can cause injury or damage. Additionally, rotation in the opposite direction is inefficient. When releasing the force causing the rotation enables rotation in the opposite direction, recapturing the rotation lost is repetitive. Controlling the rotation is desirable.

### SUMMARY

In a first aspect, the disclosure provides a device to control rotation. The device includes a stationary portion having an internal aperture with a frustoconical inner surface. A movable portion is also included, having a frustoconical outer surface, adapted to engage the frustoconical inner surface, so as to stop rotation between the movable portion and the stationary portion when engaged. The device also includes an input sleeve, the input sleeve configured to transmit an applied rotational force to the device, the input sleeve also configured so that, as the input sleeve moves in a first axial direction, the moveable portion engages the stationary portion, and as the input sleeve moves in a second and opposite axial direction, the moveable portion is pushed out of engagement with the stationary portion, the input sleeve having a cam slot, which cam slot has a shape of a partial helix. A shaft is included, a portion of which fits within the input sleeve. The device further includes a one-way rotation governor, non-rotatably attached to the movable portion and non-rotatably attached to a shaft and configured to allow rotation between the movable portion and the shaft in one rotational direction and prevent rotation between the movable portion and the shaft in a second opposite rotational direction. A cam pin is attached to the shaft, perpendicular to the axis of rotation of the shaft. As the input sleeve is rotated in a winding direction, the cam pin moves in the cam slot and causes the input sleeve to move in the first axial direction, such that moveable portion is engaged with the stationary portion. As the input sleeve is rotated in an unwinding direction, the cam pin moves in the cam slot and causes the input sleeve to move in the second axial direction, such that the moveable portion is pushed out of engagement with the stationary portion. As the movable portion is engaged with the stationary portion, rotation of the shaft is controlled by the rotation governor, such that rotation of the input sleeve in the winding direction causes the shaft to be rotated in the winding direction, while rotation is not permitted in the unwinding direction. As the movable portion is pushed out of engagement with the stationary portion, rotation by the shaft is permitted in the unwinding direction.

In a second aspect, the disclosure provides a winch. The winch includes a rotation control device comprising: a stationary portion having a frustoconical inner surface; a movable portion having a frustoconical outer surface, adapted to engage the frustoconical inner surface, so as to stop rotation between the movable portion and the stationary portion; a one-way rotation governor non-rotatably attached to the movable portion, non-rotatably attached to an output to and configured to allow rotation between the movable portion and the output shaft in one rotational direction and prevent rotation between the movable portion and the output shaft in a second opposite rotational direction: an input sleeve configured to transmit an applied rotation force to the device, the input sleeve also configured so that, as the input sleeve moves in a first axial direction, the moveable portion engages the stationary portion, and as the input sleeve moves in a second and opposite axial direction, the moveable portion is pushed out of engagement with the stationary portion, the input sleeve also comprising a cam slot, which cam slot, defines a path with a shape of a partial helix; a shaft, a portion of which fits within the input sleeve; a cam pin attached to the shaft, perpendicular to the axis of rotation of the shaft. a winch comprising; a drive cylinder, configured to be rotated by an applied force about its longitudinal axis, about which a line is wound. The line is attached to one of a fixed object or the object to be moved. The winch is attached to the other of the fixed object or the object to be moved. The line is fed onto the winch by passing it over the drive cylinder. As the applied force is applied to the drive cylinder, a length of the line between the fixed object and the object to be moved is shortened, whereby the object is moved. As the input sleeve is rotated in a winding direction, the cam pin and the cam slot cause the input sleeve to move in the first axial direction, such that moveable portion is engaged with the stationary portion and rotation is controlled by the rotation governor which prevents rotation allows rotation of the output shaft in a winding direction and prevents rotation in an unwinding direction. As the input sleeve is rotated in an unwinding direction, the cam pin and the cam slot cause the input sleeve to move in the second axial direction, such that the moveable portion is pushed out of engagement with the stationary portion. As the movable portion is pushed out of engagement with the stationary portion, rotation by the shaft is allowed in an unwinding direction. As the line is pulled in a winding direction, the rotation governor allows the output shaft to rotate, and the winch drum rotates. As the line is pulled in an unwinding direction, the rotation governor prevents the shaft from rotating, and the winch drum is prevented from rotating.

In a third aspect, the disclosure provides a winch. The winch includes a rotation control device and a drum about which a line is wound. The rotation control device includes a stationary portion having an internal aperture with a frustoconical inner surface. A movable portion having a frustoconical outer surface, adapted to engage the frustoconical inner surface, so as to stop rotation between the movable portion and the stationary portion when engaged. An input sleeve, the input sleeve configured to transmit an applied rotational force to the device, the input sleeve also configured so that, as the input sleeve moves in a first axial direction, the moveable portion engages the stationary portion, and as the input sleeve moves in a second and opposite axial direction, the moveable portion is pushed out of engagement with the stationary portion, the input sleeve having a cam slot, which cam slot has a shape of a partial helix. A shaft, a portion of which fits within the input sleeve. A one-way rotation governor, non-rotatably attached to the movable portion and non-rotatably attached to a shaft and configured to allow rotation between the movable portion and the shaft in one rotational direction and prevent rotation between the movable portion and the shaft in a second opposite rotational direction. A cam pin attached to the shaft, perpendicular to the axis of rotation of the shaft. A stationary portion having a frustoconical inner surface. The winch includes a drive cylinder, configured to be rotated by an applied force about its longitudinal axis and having at least three drive grooves. An idler with a longitudinal axis spaced apart from the longitudinal axis of the drive cylinder. Therein, as the applied force is applied to the drive cylinder, the line is gripped by the at least three drive grooves and a length of the line between the fixed object and the object to be moved is shortened, whereby the object is moved. A line is fed onto the winch by passing it over a first of the at least three drive grooves then around the idler and then around a second of the at least three drive grooves and then around the idler and then around a third of the at least three drive grooves. The line is attached to one of a fixed object or the object to be moved. The winch is attached to the other of the fixed object or the object to be moved. The line is fed onto the winch by passing it over a first of the at least three drive grooves then around the idler and then around a second of the at least three drive grooves and then around the idler and then around a third of the at least three drive grooves. As the input sleeve is rotated in a winding direction, the cam pin and the cam slot cause the input sleeve to move in the first axial direction, such that moveable portion is engaged with the stationary portion and rotation is controlled by the rotation governor which allows rotation of the shaft in a winding direction and prevents rotation in an unwinding direction. As the input sleeve is rotated in an unwinding direction, the cam pin and the cam slot cause the input sleeve to move in the second axial direction, such that the moveable portion is pushed out of engagement with the stationary portion. As the movable portion is pushed out of engagement with the stationary portion, rotation by the output is allowed in an unwinding direction. As the line is pulled in a winding direction, the rotation governor allows the shaft to rotate, and the winch drum rotates. As the line is pulled in an unwinding direction, the rotation governor prevents the shaft from rotating, and the winch drum is prevented from rotating.

Further aspects and embodiments are provided in the foregoing drawings, detailed description and claims.

### BRIEF DESCRIPTION OF THE DRAWINGS

The following drawings are provided to illustrate certain embodiments described herein. The drawings are merely illustrative and are not intended to limit the scope of claimed inventions and are not intended to show every potential feature or embodiment of the claimed inventions. The drawings are not necessarily drawn to scale; in some instances, certain elements of the drawing may be enlarged with respect to other elements of the drawing for purposes of illustration.

FIG. 1 is an exploded view of the rotation control device.

FIG. 2 is a partial cut-away view of the rotation control device.

FIG. 3 is a partial cut-away view of the rotation control device.

FIG. 4 is a top-down cut-away view of the rotation control device at the level of the rotation governor showing how the rotation governor disengages.

FIG. 5 is a top-down cut-away view of the rotation control device at the level of the sprag clutch showing how the sprag clutch engages.

FIG. 6 is a perspective view of the winch without a line attached.

FIG. 7 is perspective view of the winch with a cross section through the drive shaft, drive roller, and idler roller.

FIG. 8 is a cross section through the longitudinal axis of the winch.

FIG. 9 is a perspective view of the winch including the line threaded through the winch.

### DETAILED DESCRIPTION

The following description recites various aspects and embodiments of the inventions disclosed herein. No particular embodiment is intended to define the scope of the invention. Rather, the embodiments provide non-limiting examples of various compositions, and methods that are included within the scope of the claimed inventions. The description is to be read from the perspective of one of ordinary skill in the art. Therefore, information that is well known to the ordinarily skilled artisan is not necessarily included.

### Definitions

The following terms and phrases have the meanings indicated below, unless otherwise provided herein. This disclosure may employ other terms and phrases not expressly defined herein. Such other terms and phrases shall have the meanings that they would possess within the context of this disclosure to those of ordinary skill in the art. In some instances, a term or phrase may be defined in the singular or plural. In such instances, it is understood that any term in the singular may include its plural counterpart and vice versa, unless expressly indicated to the contrary.

As used herein, the singular forms “a,” “an,” and “the” include plural referents unless the context clearly dictates otherwise. For example, reference to “a substituent” encompasses a single substituent as well as two or more substituents, and the like.

As used herein, “for example,” “for instance,” “such as,” or “including” are meant to introduce examples that further clarify more general subject matter. Unless otherwise expressly indicated, such examples are provided only as an aid for understanding embodiments illustrated in the present disclosure and are not meant to be limiting in any fashion. Nor do these phrases indicate any kind of preference for the disclosed embodiment.

A device for controlling rotation is described. The rotation control device includes a brake housing, or stationary portion, and a brake pad, or movable portion. The brake pad is frustoconically shaped, and the brake housing has a corresponding internal shape so that the brake and brake housing fit snuggly together, enabling friction between the brake and brake housing to stop relative rotation.

The resting or unarticulated state of the rotation control device is in a stop position with the cone being pushed into the brake housing. This is accomplished by a spring. The spring is placed between the outer housing and the cone and pushes on the cone. The spring is kept in place by a spring perch. Between the perch and the cone is a bushing, hereinafter referred to as a spring bushing. This bushing reduces the friction between the separate parts.

Within the cone is a recess, and within the recess is a rotation governor, in some embodiments the rotation governor is a sprag clutch. The sprag clutch enables rotation in one direction but not in the other. A sprag clutch serves as a one-way freewheel clutch. The sprag clutch is similar to a roller bearing, however, where a roller bearing includes rollers to decrease friction and enable smoother rolling, a sprag clutch has sprags, which are typically asymmetrical and figure eight shaped. When the sprag clutch is rotated in one direction, the sprags slip, or freewheel enabling movement. When the sprag clutch is rotated in the other direction, the sprags catch, causing a wedging action and preventing rotation. In other embodiments, the rotation governor is a ratchet. The rotation governor may be any device that allows rotation in a first direction and restricts or stops rotation in a second direction.

A shaft transmits the rotation from the input to a drum. The shaft connects to the sprag clutch and to the drum. The shaft also connects to the input. The input is where the rotational force comes from. In some embodiments, the input is a sleeve with an input interface. The input interface enables a tool to be used to generate rotational force. In some embodiments, the rotational force is applied by a handle. In some embodiments, the rotational force is applied by a tool such as a cordless drill. The input interface may be any of a variety of tool interfaces, such as in one embodiment a hex head, as would fit within a hex wrench or ratchet tool. In another embodiment, the interface may be a recessed square or cube, such as is used to connect a ratchet with its bits.

The input sleeve also includes a cam slot. The shaft includes a cam pin. The input sleeve fits over the shaft. The cam pin is located near the end of the shaft nearest the input. The cam pin of the shaft fits within the cam slot of the input sleeve. As the input sleeve is rotated, the cam pin slides in the cam slot. The cam pin sliding in the cam slot serves three purposes. First, the cam pin in the cam slot keeps the input sleeve attached to the shaft. Second, the input sleeve rotates around the shaft until the cam pin comes in contact with a first end and a second end of the cam slot, once the cam pin contacts either the first end or the second end of the cam slot, the shaft is rotated in the same direction as the input sleeve. The cam slot is angled so as to push the input sleeve toward the cone.

When the input is rotated in one direction the input sleeve is pushed toward the cone. The sleeve pushes a sliding collar. The sliding collar pushes against the cone. The cone and rotation governor is pushed against the spring. As the collar pushes against the cone and the cone pushes against the spring, the cone is removed from contact with the brake housing. When the cone is removed from contact with the brake housing, the shaft is free to rotate in either direction.

The rotation control device may be used with any device that rotates some examples include winches, capstan winches, and scissors jacks.

In one embodiment, the rotation control device is used with a winch, such as a capstan winch. A capstan winch does not wind the line onto a drum, instead it wraps at least a portion of the line around a drum. As the drum is rotated the one end of the line is drawn closer to the drum and the other end of the line is fed off of the drum. To initiate use of the capstan winch to pull something the other end of the line is fed through the capstan winch and the drum is rotated. To feed the line onto the drum it is desirable to be able to pull the line. As the line is pulled the drum rotates.

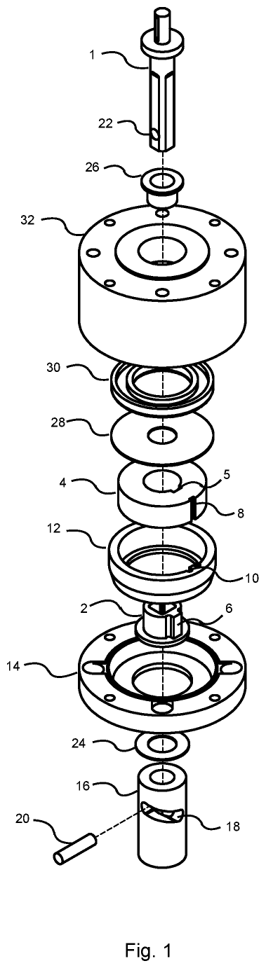

The rotation control device includes a brake housing, a brake, a sprag clutch, an input sleeve, an input bushing, a sliding collar, a shaft, a flange bearing, a spring bushing, and a spring perch. FIG. 1 is an exploded view of the device with the components individually visible. An input shaft 1 transfers the rotation to the rotating device which attaches at the top of the input shaft. The input shaft 1 passes through the other components of the device. In some embodiments, the input shaft has a square shape, that is the shaft is not a cylinder, instead it has four faces where each face is parallel to the axis of rotation. In alternative embodiments, the shaft has another number of faces. In some embodiments, the shaft has three faces. In another embodiment, the shaft has five faces, in another embodiment, the shaft has six faces. In other embodiments, the shaft has another number of faces.

The shape of the shaft enables the shaft to interact with the other components of the rotation control device. The shaft fits into a sliding collar 2, where the sliding collar is shaped to accept the shaft. The sliding collar 2 is shaped to fit into the sprag clutch 4. The shape of the sliding collar 2 is substantially cylindrical with a protrusion 6, the rotation governor, which in some embodiments is a sprag clutch 4, fits around the sliding collar 2 and has a divot 8 in the inner circumference, where the protrusion 6 of the sliding collar fits 2. The design of the sliding collar 2 fitting into and affixing the sliding collar 2 to the sprag clutch 4 is often referred to as being keyed together. The protrusion of the sliding collar 2 fits into the divot 5 of the one-way rotation governor 4, which in this embodiment is a sprag clutch, and turns the rotation governor 4, in a way similar to a key turning a lock.

The one-way rotation governor, or sprag clutch 4 includes a divot 8 in the outer circumference into which is fit a protrusion 10 in the movable portion 12, also referred to as a cone, of the cone brake. The sprag clutch 4 is keyed to fit into the movable portion or cone 12. The divot 8 in the outer circumference of the sprag clutch 4 being keyed to fit into the protrusion of the cone 12 is one method of affixing the cone to the sprag clutch. The design of the key could be reversed where the divot is in the cone and the protrusion is on the sprag clutch. Additional divot and protrusion pairs can be used to affix the cone to the sprag clutch. Other methods of affixing the sprag clutch to the cone include welding, sintering, and bonding with adhesives.

These shapes are designed to enable the components to move together in specific ways. The square shape of the input shaft 1 fits into the square shaped sliding collar 2, which enables the input shaft 1 to turn the sliding collar 2. The sliding collar 2 is keyed to fit into the sprag clutch 4, which turns the sprag clutch 4. The sprag clutch 4 is keyed to fit within the cone brake 12, so when the sprag clutch 4 is turned, the cone brake 12 is turned.

The movable portion or cone 12 of the cone brake interacts with a stationary portion 14, also known as a brake housing. The movable portion or brake housing 14 is made of a durable hard material. In some embodiments, this is steel, in some other embodiments it is stainless steel. The cone 12, which can be thought of as the brake pad is also made of a durable material. However, it is advantageous for the cone 12 to be made from a different material. This is in part due to the process of galling, whereby when two surfaces move against each other they seize up. In most instances, this seizing is the result of cold welding, and is most common when the surfaces are constructed of the same material. By constructing the cone 12 from a material different than that of the brake housing 14, the possibility of galling is reduced. In some embodiments, the material of the cone 12 is softer than the material of the brake housing 14. In addition to lessening the possibility of galling, constructing the cone 12 of a softer material increases the friction between the cone 12 and the brake housing 14, which in turn increases the braking power of the rotation control device. In some embodiments, the cone 12 is made of brass. In some other embodiments, the cone brake 12 is make of another metal or metallic alloy.

An input sleeve 16 is rotated to rotate the input shaft 1. The input sleeve includes a rotation initiation interface. The rotation initiation interface accepts a rotation initiation tool. In some embodiments, the rotation initiation interface is a square shaped recess, such as that used with a standard rachet wrench. In some embodiments, the rotation initiation interface is a hexagonal shaped recess, such that could be used with a hex or Allen wrench. In yet other embodiments, the rotation initiation interface is a hexagonal protrusion, such that a socket wrench could fit over. In some embodiments, the rotation initiation tool is a handle. In some embodiments, the rotation initiation tool is a drill. In some embodiments, the drill is a battery powered drill.

The input sleeve 16 fits around the input shaft 1. The input sleeve 16 includes a cam slot 18. The cam slot has the shape of a partial helix. A full helix would coil all the way around the input sleeve. The partial helix coils partway around the input sleeve. In some embodiments, the cam slot is shaped or coils around half the circumference of the input sleeve. In some embodiments, the cam slot is shaped or coils around one fourth of the circumference of the input sleeve. A cam pin 20 is attached to the input shaft 1. The cam pin 20 is oriented perpendicular to the axis of rotation of the input shaft, in a pin aperture 22. The cam pin 20 rides in the cam slot 18. Rotating the input sleeve 16 will cause the cam pin 20 to move in the cam slot. As the cam pin 20 moves in the cam slot 18, the cam sleeve moves axially.

A spring (not shown) pushes the cone 12 into contact with the brake housing 14. The spring fits within a spring perch 30. The spring pushing the cone 12 into contact with the brake housing 14 applies the force to provide friction to keep the cone from rotating within the brake housing.

A gearbox housing 32 fits around and protects the components.

There are several bearings in the rotation control device, these bearing help reduce friction between working components. Between the input sleeve 16 and the sliding collar 2 is an input bushing 24. The input bushing 24 helps reduce friction between the input sleeve 16 and sliding collar 2. A flange bearing 26 helps reduce friction around the top of the input shaft 1. A spring bushing 28 is between the sprag clutch 4 and the spring perch 30.

The device is rotatable to cause rotation of a winch or other rotational device. The device transmits rotation from an input, the direction of rotation from the input may be in either direction. The device is further designed to allow rotation from a drum, and the rotation from the drum side is allowed in one direction and not in the other direction.

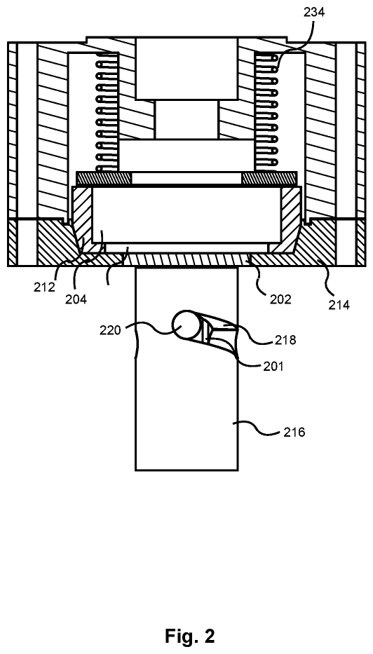

FIG. 2 is a cut-away view of the rotation control device. The rotation control device inhibits motion through friction between the movable portion or cone 212 and the stationary portion or brake housing 214. A spring 232 is extended and pushes the cone 212 into the brake housing 214. The cone 212 can be thought of as a brake pad, and the brake housing 214 can be thought of as the brake rotor. The movable portion or cone 212 is cone shaped, or more accurately the cone is frustoconical in shape. The stationary portion or brake housing 214 has a corresponding shape, so that the cone 212 fits snuggly within the brake housing 214. The outer surface of the movable portion or cone is frustoconical and fits within the internal aperture of the stationary portion or brake housing. Ideally, the cone 212 and the brake housing 214 fit so well together that there is no space between them. With the cone 212 being constructed of a material that is softer than the brake housing 214, the cone 212 will eventually wear away until the cone 212 and the brake housing 214 fit together with no gaps. The tighter the fit, the more friction is produced between the cone 212 and the brake housing 214.

In FIG. 2, the input sleeve 216 is not cut away. As the input sleeve is rotated, the cam pin 220 moves in the cam slot 218. As the cam slot is a partial helix, the cam slot imparts axial movement as well as rotational movement to the shaft connected to the cam pin. The cam pin 220 is attached to the input shaft 201. When the input sleeve 216 is rotated in the clockwise direction (in FIG. 2 this is to the right), the cam pin 220 follows the cam slot 218. As the cam pin moves in the cam slot, the input sleeve moves in a first axial direction. This movement in a first axial direction causes the input sleeve to be positioned so as to keep the cone 212 in contact with the brake housing 214. When the input sleeve 216 is rotated clockwise and the input sleeve 216 comes into contact with the cam pin 220, the input shaft 201 is rotated in the clockwise direction. When the input shaft 201 is rotated in the clockwise direction, the cone 212, remains in contact with the brake housing 214, and does not rotate. When the cone 212 does not rotate when the input shaft 201 is rotated in the clockwise direction, the input shaft 201 causes the rotation governor, in the present embodiment, a sprag clutch, to rotate. The sprag clutch rotates in a single direction. In the embodiment currently described, the sprags of the sprag clutch allow rotation in the clockwise direction. The input shaft will not rotate the sprag clutch in the counterclockwise direction, this is because of the design of the sprag clutch, which locks up when attempted to rotate in the counterclockwise direction.

This unidirectional movement is beneficial in pulling the end of a line toward a drum. In a winch a line is wound onto a drum and if the rotation control device mechanism is used with a winch the sprag clutch would allow the line to be wound onto the winch drum but would prevent the line from being pulled of the drum when the line is pulled. Another type of pulling device, a capstan winch, does not wind a line onto a drum, but pulls the line toward a drum and feeds the line off the drum. In capstan winch embodiments, the sprag clutch will rotate and pull one end of the line toward the drum but will not allow rotation if that end of the line is pulled.

This unidirectional movement is also beneficial in turning a screw designed to lift objects, such as a car jack or “man lift.” In a lifting embodiment, the screw is turned, and arms are brought close together, causing lifting. In these embodiments, the weight can be great enough to reverse the direction of the screw, causing the jack to move downward. Use of the rotation control device would prevent the weight from causing the jack to move downward.

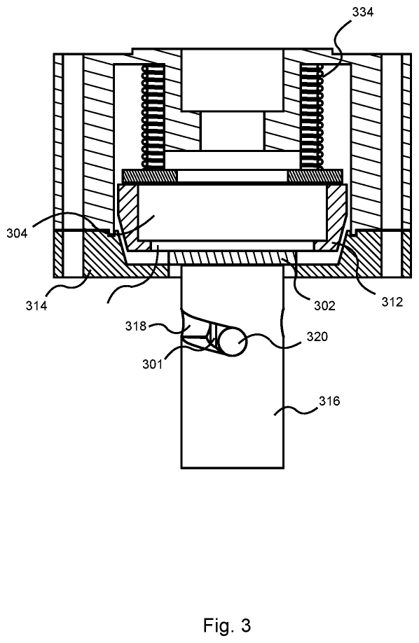

FIG. 3 is a cut away view of the rotation control device. The rotation control device is designed to inhibit motion through friction between the movable portion or cone 312 and the stationary portion or brake housing 314, when the cone 312 is in contact with the brake housing 314. The rotation control device is designed to enable motion when the cone 312 is not in contact with the rotation control device 314. When the spring 334 is compressed the cone 312 is taken out of contact with the brake housing 314 the friction between the cone brake 312 and the brake housing 314 is eliminated.

In FIG. 3, the rotation control device is depicted in an unengaged position. In the figure, the input sleeve 316 is not cut away. As the input sleeve is rotated, the cam pin 320 moves in the cam slot 318. The cam pin 320 is attached to the input shaft 301. When the input sleeve 316 is rotated in the counterclockwise direction (in FIG. 3 this is to the left), the cam pin 320 follows the cam slot 318. As the cam pin moves in the cam slot, the input sleeve moves in a second axial direction. This movement in a second axial direction lifts the cone 312 out of contact with the brake housing 318. When the input sleeve 316 is rotated counterclockwise the input sleeve 316 follows the path of the cam slot 318. As the cam slot 318 rides on the cam pin 320, the input sleeve 316 and the sliding collar 302 are directed toward the cone 312. Once the cam pin reaches a second end of the cam slot, the rotation of the input sleeve will cause the shaft to rotate. The input busing 324 reduces friction between the cone and the sliding collar. Directing the input sleeve 316 and the sliding collar 302 toward the cone 312 causes the cone 312 to be lifted away from the brake housing 314. In addition to lifting the cone 312 away from the brake housing 314 rotating the input sleeve 316 in the counterclockwise direction causes the input shaft 301 to be rotated in the counterclockwise direction.

In the embodiment currently described, the sprags of the sprag clutch allow rotation in the clockwise direction. The input shaft will not rotate the sprag clutch in the counterclockwise direction, this is because of the design of the sprag clutch, which locks up when attempted to rotate in the counterclockwise direction.

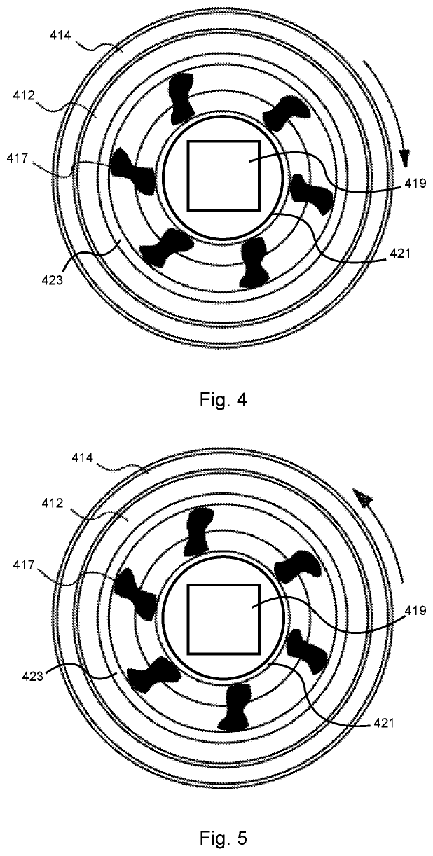

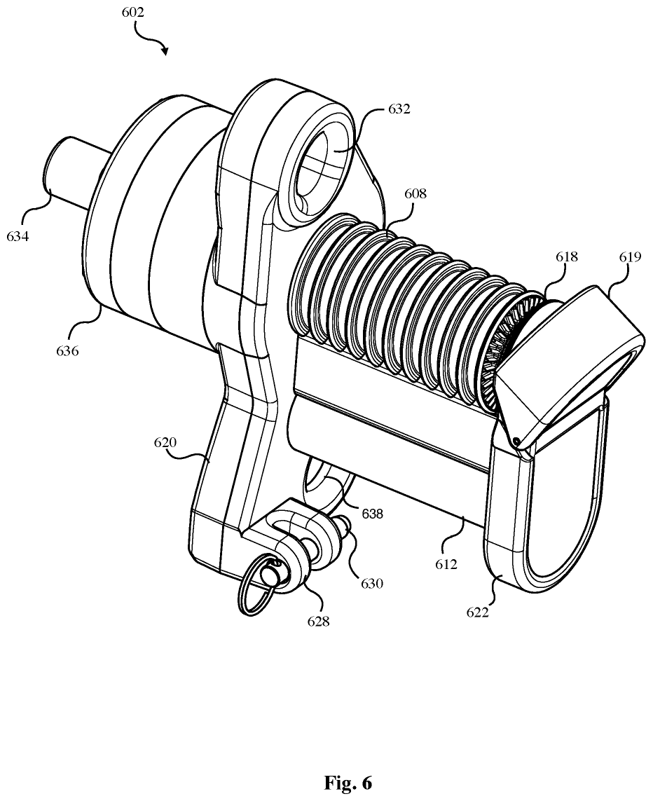

FIGS. 4-5 show how the rotation governor enables rotation in one direction and inhibits rotation in another direction. In the depicted embodiment, the rotation governor is a sprag clutch. A cut-away view of the in the sprag clutch in the rotation control device, as seen in FIG. 4 a top-down cut-away view shows the brake housing 414, the cone 412, and the sprag clutch 404. The bore 419 of the sprag clutch is square so as to interact with the input shaft which has a square cross section. The square bore interacting with the input shaft enables the sprag clutch to be the determining component of the rotation control device. The rest of the components in the rotation control device have round bores. A round bore will not interact with the input shaft. The sprag clutch is keyed into the cone brake so the turning of the sprag clutch can turn the cone brake, such as when the sprag clutch is engaged and the cone brake is moved out of contact with the brake housing. The sprag clutch includes sprags such as sprag 417. The sprag clutch functions similarly to a bearing with the sprags being located between an inner race 421 and an outer race 423. When the sprag clutch is rotated in the clockwise direction, as in FIG. 4, the sprags, such as sprag 417, do not engage, either the inner race or the outer race, enabling the clutch to rotate. When the sprag clutch is rotated in the counterclockwise direction, as in FIG. 5, the sprags, such as sprag 417, engage, with both the inner race and the outer race, locking the inner race 421 and outer race 423 together, and preventing rotation of the sprag cutch.

The rotation control device with its combination of brake and sprag clutch enables control of the rotation of a shaft. The brake stops rotation in either direction of the cone, while the cone is in contact with the brake housing. Lifting the cone out of contact with the brake housing enables rotation. Affixing a rotation governor, such as a sprag clutch, within the cone, increases the control over the rotation of a shaft. The sprag clutch will allow rotation in a first direction and eliminate rotation in a second direction, this enables rotation in a first direction without the possibility of the shaft slipping in the second direction. This is particularly useful in situations where rotation of the shaft in one direction creates or increases a load on the shaft which would result in the shaft rotating the second direction if the force causing the rotation is released. In these situations, stopping rotation in the second direction is more efficient and safer than allowing rotation in the second direction.

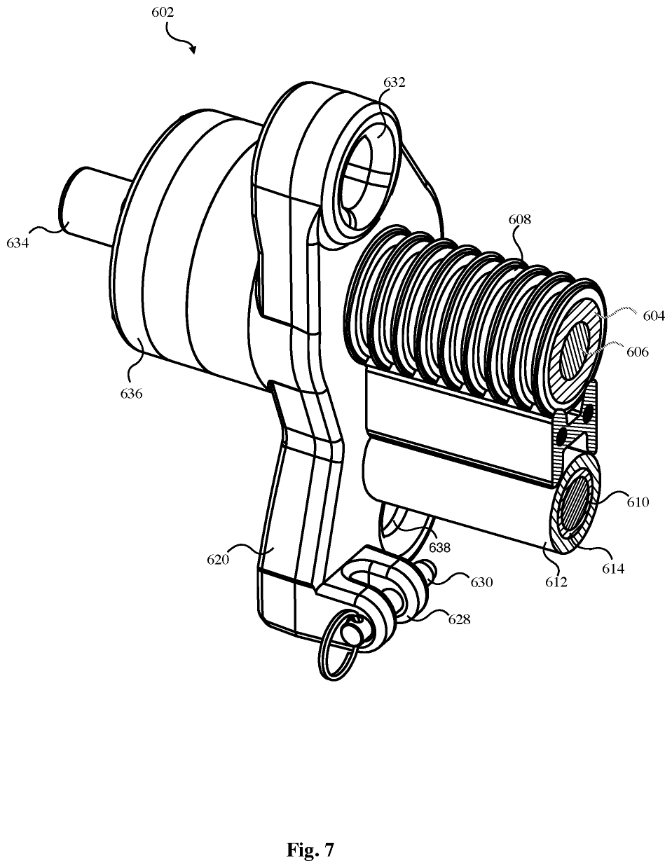

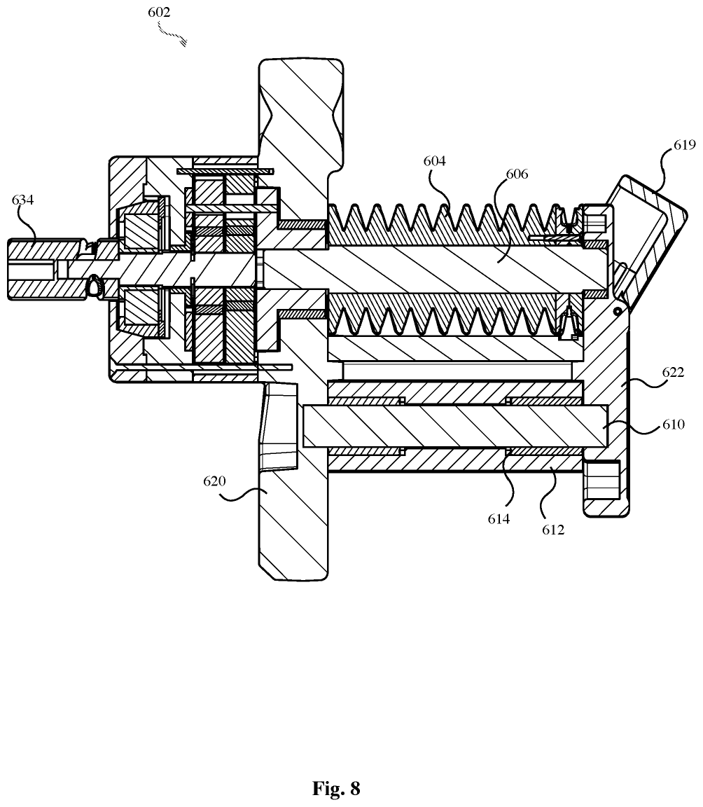

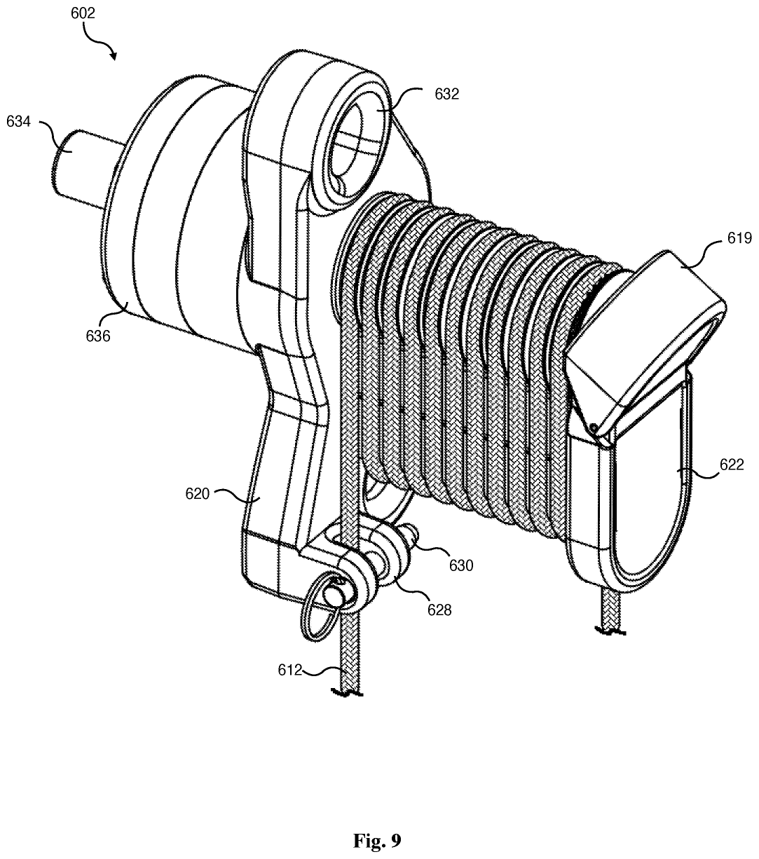

The rotation control device is an effective mechanism for adding safety and functionality to a winch. FIGS. 6-9 depict one embodiment of a winch using the rotation control device. FIG. 8 shows the rotation control device and winch in cross section, providing a view of the integration of the rotation control device in the winch device.

In a primary embodiment, as seen in FIGS. 6-9, a capstan winch 602 includes a drive cylinder 604 which rotates, about its longitudinal axis, on a drive shaft 606. The drive cylinder 604 has drive grooves, such as drive groove 608, that are parallel to one another and perpendicular to the long axis of the drive shaft 606 and drive cylinder 604. Parallel to the longitudinal axis of drive shaft 606 is an idler shaft 610 on which an idler roller 612 rotates. Between the idler shaft 610 and the idler roller are idler bearings 614 the bearings decrease the friction on the roller and assist in the roller being free spinning. As the idler roller 612 rotates, the line aligns with a second of the drive grooves. This continues across the drive cylinder 604, with each drive groove, being fed line 616 from the roller. The wrapping and tension of the line from the drive cylinder and the idler roller produces a capstan effect on the line 616, reducing the force required to turn the drive cylinder 4 and draw the line in, pulling the object. Turning the drive cylinder 604 counterclockwise causes the line to be drawn out.

The surface of the grooves is preferably designed to provide the right balance between friction and wear on the line. In other words, the total surface of the grooves that engages the line need to have enough friction, i.e., grip, with the line so that the line can be pulled by rotation of the drive cylinder. Likewise, the surface of the grooves should not have so much friction, e.g., roughness, so that the line wears unnecessarily as it is passed over the grooves repeatedly.

The more grooves and the larger the area of contact between the grooves and the line means that each groove needs less friction. In some embodiments, there are three drive grooves. In other embodiments, there are two drive grooves. In a preferred embodiment, there are at least five grooves. In a more preferred embodiment, as in FIGS. 6-9, there are at least 11 grooves. The fewer the grooves, the greater the friction required on the surface of the drive grooves or force supplied by another tensioning device. The surface of the grooves can be tailored with special coatings, such as a soft polymeric coating, e.g., urethane or rubber, that would provide a better grip on the line. Alternatively, the surface of the grooves can be roughened, for example by etching, abrading or the like. Also, the outer surface of the line itself may be tailored with polymers coatings and the like, to provide more grip on the rollers.

In some embodiments, one of the drive grooves includes line gripping features. As seen in FIGS. 6-9, the final drive groove 618 is ribbed to provide more grip on the line. As depicted by FIGS. 1-5, this is the drive groove furthest to the right, or furthest from the drive mechanism. This drive groove is referred to as the final drive groove because it is the final groove as the line is wound onto the winch to pull the end of the line toward the winch. The grip of this final drive groove assists in starting the line winding in. The ribs extend from the center of the drive groove to the edge of the drive groove. The ribs grip the line. In some embodiments, the ribs of the drive groove mirror each other. In these embodiments, the ribs on one side of the drive groove align with the ribs on the other side of the drive groove.

A line hood 619 opens to allow the line to be looped over the ribbed final drive groove 618. When ready to begin pulling the line 616 to the winch, the line hood is folded into place keeping the line in contact with the ribbed final drive groove 618.

The winch includes frame elements to hold the drive shaft 606 and idler shaft 610. A first frame element 620, holds a first end of the drive shaft 606 and idler shaft 610. A second frame element 622 holds a second end of the drive shaft 606 and a second end of the idler shaft 610. The drive shaft 606 passes through first frame element 620 and connects to drive mechanism 624. Drive mechanism 624 connects to input sleeve 626. The input sleeve 626 is designed to enable a handle to connect to the input sleeve 626 and turn the drive mechanism 624 and thus the drive shaft.

First frame element 620 includes a line guide 628. The line guide 628 holds the line in place. The line guide 628 ensures that the line is spooled onto the first drive groove of the drive cylinder. In addition to directing the line onto the first drive groove, the line guide assists in keeping the winch properly aligned as it pulls one end of the line toward the winch. The line guide ensures that the which will not rotate as the line is spooled onto the drive cylinder. In some embodiments, the line guide is machined separately from the frame element. In these embodiments, the line guide is then attached to the frame element. Any one of multiple attachment methods are used to connect the line guide to the frame element and include welding the line guide to the frame element, bolting the line guide to the frame element, and bolting through the frame element. In other embodiments, the line guide is integral to the first frame element. In some embodiments, the line guide is formed by two protrusions from the first frame element. The first frame element, and the protrusions form sides of the line guide. This leaves an open side through which the line can be placed in the line guide. In some embodiments the open side of the line guide is closed by inserting a pin 630 through the two protrusions. By inserting pin 30 through the two protrusions an aperture is formed, through which the line can pass. Because the pin 630 is removable, the line does not have to be threaded through the line guide 628. By removing the pin 630 from one side of the line guide 628, the line can be placed into the line guide 630 at any point along the line. This enables the line to be wound onto the winch by looping the line around the drive cylinder 604 and the idler roller 612. As long as the line is placed in the drive grooves 8 without the line crossing between two grooves, the line will feed from one drive groove to the next. This is true even if the line initially crosses over itself on the idler roller. The line need not pass over every drive groove. It is possible for the winch to function without the line passing over every drive groove. The more drive grooves used the larger the force multiplied to pull an object. Each drive groove is essentially a pulley, so each drive groove used increases the force on the end of the line.

The first frame element also includes a first attachment aperture 632 which is used to attach the winch to an object. In some embodiments, the first attachment aperture 632 is integral to the first frame element. In some embodiments, the first frame aperture 632 is located opposite the line guide. Most often the winch is attached to a stationary object that would be difficult to move. Examples of such objects include trees, vehicles, or other large objects. The attachment aperture 632 allows a rope, carabiner, quick link, loop or other securing device to pass through the first frame element and secure it to the stationary object. By placing the attachment aperture within the first frame element a strong place through which to secure the winch is created. By placing an attachment aperture through the frame, a user will not attempt to attach the winch using another part of the winch, which could damage the winch or interfere with proper use of the winch. The aperture is also through the strongest part of the winch which leads to a longer functional life of the winch. The aperture is sized to enable a number of securing options, including rope loops, straps, chains or other securing methods. The positioning of the first frame aperture and the line guide decreases the possibility of the stationary object or the securing device interfering with the line spooling onto the winch. In some embodiments, a second attachment aperture 638 is located in the first frame element.

The frame elements need to be strong enough to withstand the forces placed on them. Those forces include the weight of all the mechanisms attached to the frame elements, the pulling force of the line, the force of the securing device, the compressive forces of the loops of the line on the attachments from the drive and roller shafts. In order to withstand these forces, the frame elements are constructed of materials that will hold up to these demands. In some embodiments, the frame elements are constructed of steel. In some of these embodiments the steel is steel plate that is from half an inch thick to one inch thick. In some embodiments, the frame elements are constructed of machined steel. The machined steel is from half an inch thick to one and a half inches thick and is machined so that differing areas of the frame have strengthening portions and lightening portions. In another embodiment, the frame elements are constructed of other metals such as aluminum, anodized aluminum, titanium, magnesium, and alloys of any of these metals. In some embodiments, the frame elements are constructed of carbon fiber. In some other embodiments, the frame elements are constructed of combinations of a metal and carbon fiber.

All patents and published patent applications referred to herein are incorporated herein by reference. The invention has been described with reference to various specific and preferred embodiments and techniques. Nevertheless, it is understood that many variations and modifications may be made while remaining within the spirit and scope of the invention.

What is claimed is:

1. A device to control rotation comprising:
a stationary portion having an internal aperture with a frustoconical inner surface;
a movable portion having a frustoconical outer surface, adapted to engage the frustoconical inner surface, so as to stop rotation between the movable portion and the stationary portion when engaged;
an input sleeve, the input sleeve configured to transmit an applied rotational force to the device, the input sleeve also configured so that, as the input sleeve moves in a first axial direction, the moveable portion engages the stationary portion, and as the input sleeve moves in a second and opposite axial direction, the moveable portion is pushed out of engagement with the stationary portion, the input sleeve having a cam slot, which cam slot has a shape of a partial helix;
a shaft, a portion of which fits within the input sleeve;
a one-way rotation governor, non-rotatably attached to the movable portion and non-rotatably attached to a shaft and configured to allow rotation between the movable portion and the shaft in one rotational direction and prevent rotation between the movable portion and the shaft in a second opposite rotational direction;
a cam pin attached to the shaft, perpendicular to the axis of rotation of the shaft;
wherein,
as the input sleeve is rotated in a winding direction, the cam pin moves in the cam slot and causes the input sleeve to move in the first axial direction, such that moveable portion is engaged with the stationary portion;
as the input sleeve is rotated in an unwinding direction, the cam pin moves in the cam slot and causes the input sleeve to move in the second axial direction, such that the moveable portion is pushed out of engagement with the stationary portion;
wherein, as the movable portion is engaged with the stationary portion, rotation of the shaft is controlled by the rotation governor, such that rotation of the input sleeve in the winding direction causes the shaft to be rotated in the winding direction, while rotation is not permitted in the unwinding direction;
wherein, as the movable portion is pushed out of engagement with the stationary portion, rotation by the shaft is permitted in the unwinding direction.

2. The device of claim 1, wherein the rotation governor comprises:
a bore through which the shaft passes, and which is shaped so as to interact with the shaft;
an inner race;
an outer race;
sprags positioned between the inner race and the outer race;
wherein as the shaft is rotated in the winding direction, the sprags are not engaging with either the inner race or the outer race, allowing the shaft to rotate;
wherein as the shaft is rotated in the unwinding direction, the sprags engage with both the inner race and the outer race, preventing the shaft from rotating.

3. The device of claim 1, wherein as the cam pin reaches a first end of the cam slot, the input sleeve rotates the shaft in a first direction and as the cam pin reaches a second end of the cam slot, the input sleeve rotates the shaft in a second direction.

4. The device of claim 1, further comprising a spring for pushing the movable portion into contact with the stationary portion.

5. The device of claim 4, wherein rotation of the input sleeve in the unwinding direction is configured to cause the cam pin to move in the cam slot causing the input sleeve to move in the second axial direction, pushing the spring, such that the moveable portion is pushed out of engagement with the stationary portion.

6. The device of claim 1, wherein the rotation governor is embedded within the movable portion.

7. The device of claim 6, wherein the rotation governor is keyed to the movable portion.

8. The device of claim 1, wherein the input sleeve is rotated by a motor.

9. The device of claim 8, wherein the motor is part of a hand drill.

10. The device of claim 1, wherein the input sleeve is rotated manually.

11. A winch comprising:
a rotation control device comprising:
a stationary portion having a frustoconical inner surface;
a movable portion having a frustoconical outer surface, adapted to engage the frustoconical inner surface, so as to stop rotation between the movable portion and the stationary portion;
a one-way rotation governor non-rotatably attached to the movable portion, non-rotatably attached to an output to and configured to allow rotation between the movable portion and the output shaft in one rotational direction and prevent rotation between the movable portion and the output shaft in a second opposite rotational direction;
an input sleeve configured to transmit an applied rotation force to the device, the input sleeve also configured so that, as the input sleeve moves in a first axial direction, the moveable portion engages the stationary portion, and as the input sleeve moves in a second and opposite axial direction, the moveable portion is pushed out of engagement with the stationary portion, the input sleeve also comprising a cam slot, which cam slot, defines a path with a shape of a partial helix;
a shaft, a portion of which fits within the input sleeve;
a cam pin attached to the shaft, perpendicular to the axis of rotation of the shaft;
a drive cylinder, configured to be rotated by an applied force about its longitudinal axis, about which a line is wound;
the line is attached to one of a fixed object or the object to be moved;
the winch is attached to the other of the fixed object or the object to be moved;
a line is fed onto the winch by passing it over the drive cylinder;
wherein, as the applied force is applied to the drive cylinder, a length of the line between the fixed object and the object to be moved is shortened, whereby the object is moved;
wherein, as the input sleeve is rotated in a winding direction, the cam pin and the cam slot cause the input sleeve to move in the first axial direction, such that moveable portion is engaged with the stationary portion and rotation is controlled by the rotation governor which prevents rotation allows rotation of the output shaft in a winding direction and prevents rotation in an unwinding direction;
as the input sleeve is rotated in an unwinding direction, the cam pin and the cam slot cause the input sleeve to move in the second axial direction, such that the moveable portion is pushed out of engagement with the stationary portion;
wherein, as the movable portion is pushed out of engagement with the stationary portion, rotation by the shaft is allowed in an unwinding direction;
wherein as the line is pulled in a winding direction, the rotation governor allows the output shaft to rotate, and the winch drum rotates;
wherein as the line is pulled in an unwinding direction, the rotation governor prevents the shaft from rotating, and the winch drum is prevented from rotating.

12. The device of claim 11, further comprising a spring for pushing the movable portion into contact with the stationary portion.

13. The device of claim 12, wherein rotation of the input sleeve in the unwinding direction is configured to cause the cam pin to move in the cam slot to cause the input sleeve to move in the second axial direction, pushing the spring, such that the moveable portion is pushed out of engagement with the stationary portion.

14. The device of claim 11, wherein the rotation governor is embedded within the movable portion.

15. The device of claim 14, wherein the rotation governor is keyed to the movable portion.

16. The device of claim 16, wherein the input sleeve further comprises a rotation initiation interface.

17. The device of claim 17, wherein the rotation initiation interface is hexagonal.

18. The device of claim 11, wherein the input sleeve is rotated by a motor.

19. A winch comprising:
a stationary portion having an internal aperture with a frustoconical inner surface;
a movable portion having a frustoconical outer surface, adapted to engage the frustoconical inner surface, so as to stop rotation between the movable portion and the stationary portion when engaged;
an input sleeve, the input sleeve configured to transmit an applied rotational force to the device, the input sleeve also configured so that, as the input sleeve moves in a first axial direction, the moveable portion engages the stationary portion, and as the input sleeve moves in a second and opposite axial direction, the moveable portion is pushed out of engagement with the stationary portion, the input sleeve having a cam slot, which cam slot has a shape of a partial helix;
a shaft, a portion of which fits within the input sleeve;
a one-way rotation governor, non-rotatably attached to the movable portion and non-rotatably attached to a shaft and configured to allow rotation between the movable portion and the shaft in one rotational direction and prevent rotation between the movable portion and the shaft in a second opposite rotational direction;
a cam pin attached to the shaft, perpendicular to the axis of rotation of the shaft;
a drive cylinder, configured to be rotated by an applied force about its longitudinal axis and having at least three drive grooves;
an idler with a longitudinal axis spaced apart from the longitudinal axis of the drive cylinder;
wherein, as the applied force is applied to the drive cylinder, the line is gripped by the at least three drive grooves and a length of the line between the fixed object and the object to be moved is shortened, whereby the object is moved;
wherein, a line is fed onto the winch by passing it over a first of the at least three drive grooves then around the idler and then around a second of the at least three drive grooves and then around the idler and then around a third of the at least three drive grooves;
the line is attached to one of a fixed object or the object to be moved;
the winch is attached to the other of the fixed object or the object to be moved;
a line is fed onto the winch by passing it over a first of the at least three drive grooves then around the idler and then around a second of the at least three drive grooves and then around the idler and then around a third of the at least three drive grooves;
as the input sleeve is rotated in a winding direction, the cam pin and the cam slot cause the input sleeve to move in the first axial direction, such that moveable portion is engaged with the stationary portion and rotation is controlled by the rotation governor which allows rotation of the shaft in a winding direction and prevents rotation in an unwinding direction;
as the input sleeve is rotated in an unwinding direction, the cam pin and the cam slot cause the input sleeve to move in the second axial direction, such that the moveable portion is pushed out of engagement with the stationary portion;
wherein, as the movable portion is pushed out of engagement with the stationary portion, rotation by the output is allowed in an unwinding direction;
wherein as the line is pulled in a winding direction, the rotation governor allows the shaft to rotate, and the winch drum rotates;
wherein as the line is pulled in an unwinding direction, the rotation governor prevents the shaft from rotating, and the winch drum is prevented from rotating.

20. The device of claim 11, wherein the input sleeve is rotated by a motor.
